(19) United States
(12) Patent Application Publication
(10) Pub. No.: US 2014/0325504 A1
(43) Pub. Date: Oct. 30, 2014

(54) METHOD AND SYSTEM FOR DOWNLOADING AND INSTALLING CONTROL SOFTWARE AND SMART ELECTRONIC DEVICE USING THE SAME

(71) Applicant: HON HAI PRECISION INDUSTRY CO., LTD., New Taipei (TW)

(72) Inventor: MAO-YU LIN, New Taipei (TW)

(73) Assignee: HON HAI PRECISION INDUSTRY CO., LTD., New Taipei (TW)

(21) Appl. No.: 14/252,986

(22) Filed: Apr. 15, 2014

(30) Foreign Application Priority Data
Apr. 29, 2013 (TW) 102115321

(51) Int. Cl. G06F 9/445

(52) U.S. Cl. CPC G06F 8/61
USPC 717/178

(57) ABSTRACT

Method for downloading and installing control software is provided. The method includes the following steps. Send a request from a smart electronic device to a control device for obtaining device information of the control device. Receive the device information which includes a download address of control software corresponding to the control device. Download the control software from the download address. And install the control software on the smart electronic device. A system for downloading and installing control software and a smart electronic device are also provided.

### FIELD

The present disclosure relates to remote control technology, especially to a method and system for downloading and installing control software and a smart electronic device using the same.

### BACKGROUND

Some smart electronic devices (e.g., smart phones) can be used to control household appliances. Generally, control software corresponding to a specific household appliance is installed on the smart electronic device. The control software can be used by the smart electronic device to control a specific household appliance.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts or sections throughout the drawings.

FIG. 1 illustrates a block diagram of an embodiment of a system for controlling a control device.

FIG. 2 is a block diagram of an embodiment of a system for downloading and installing control software.

FIGS. 3 and 4 together constitute a single flowchart of an embodiment of a method for downloading and installing control software.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

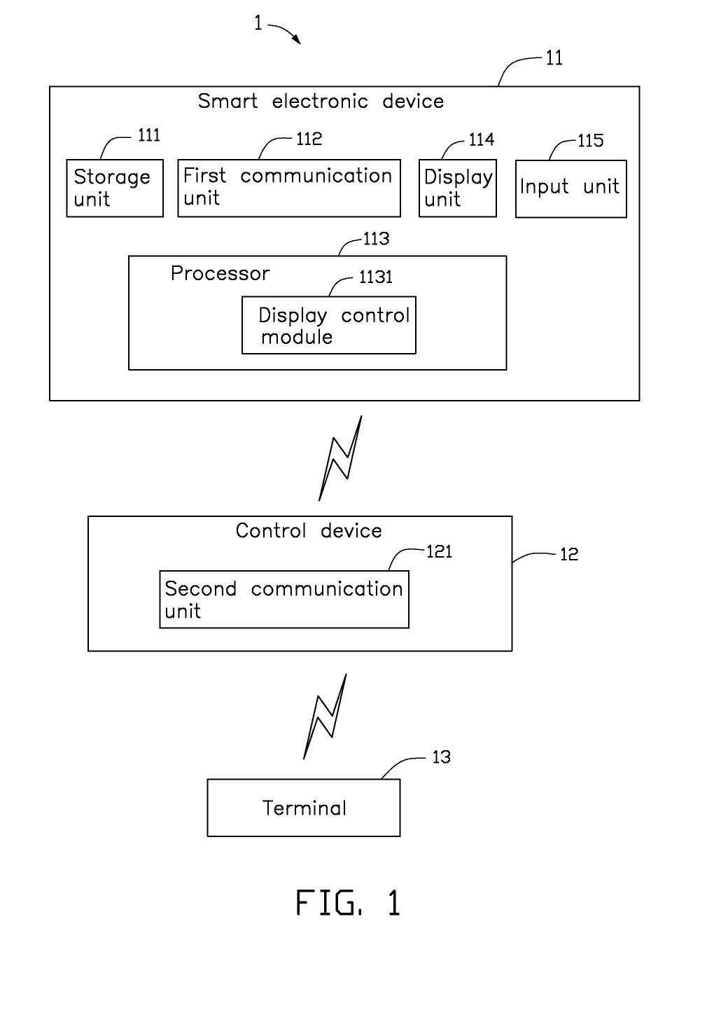

FIG. 1 illustrates an embodiment of a system 1. The system 1 can include a smart electronic device 11, a control device 12, and a terminal 13. The control device 12 is coupled to the terminal 13. The smart electronic device 11 can be a smart phone, a tablet personal computer, or other suitable electronic device. The terminal 13 can be a television, a light, an air conditioner, or other suitable household appliance. The control device 12 can be built into the terminal 13, or be an independent device.

The smart electronic device 11 is able to wirelessly communicate with the control device 12. The control device 12 can communicate with the matched terminal 13 wirelessly or through wires.

In one embodiment, the smart electronic device 11 can include a storage unit 111, a first communication unit 112, a processor 113, and a display unit 114. The storage unit 111 stores a number of control software, which can be downloaded from the Internet.

The first communication unit 112 can be a Bluetooth module, a radio frequency identification (RFID) module, or other suitable short-range communication module.

FIG. 1 illustrates one control device 12 and one terminal 13. However, a number of the control device 12 and the terminal 13 is not limited. The control device 12 can include a second communication unit 121. The second communication unit 121 is used to communicate with the first communication unit 112. The second communication unit 121 can be a Bluetooth module, an RFID module, a network interface card, or other suitable communication module.

The processor 113 can include a display control module 1131 that is used for controlling the display unit 114.

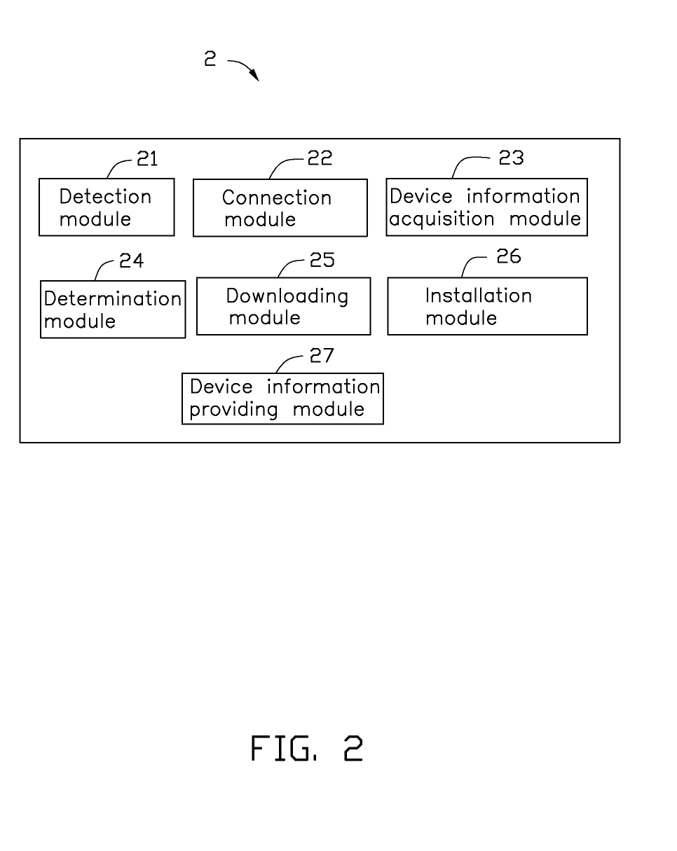

FIG. 2 is a block diagram of an embodiment of a system 2 for downloading and installing control software in the smart electronic device 11. Please also refer to the FIG. 1. In the embodiment, the system 2 can include a number of function modules, a portion of which run on the smart electronic device 11, and a portion of which run on the control device 12. In an alternative embodiment, the function modules may run only on the smart electronic device 11.

In the embodiment, the function modules of the system 2 can include a detection module 21, a connection module 22, a device information acquisition module 23, a determination module 24, a downloading module 25, and an installation module 26. The modules 21-26 can be executable by the processor 113 of the smart electronic device 11. The function modules can further include a device information providing module 27, which runs on the control device 12. In other embodiments, the function modules of the system 2 may be a collection of software instructions executable by the processor 113 of the smart electronic device 11 and the control device 12.

The detection module 21 is used for detecting whether there is a control device 12 within a predetermined range of the smart electronic device 11.

When a control device 12 is detected, the connection module 22 establishes a wireless connection between the smart electronic device 11 and the detected control device 12 via the first communication unit 112 and the second communication unit 121.

When the connection module 22 has established the wireless connection between the smart electronic device 11 and the detected control device 12, the device information acquisition module 23 generates a request for obtaining the device information of the detected control device 12, and further transmits the request to the detected control device 12.

After the second communication unit 121 of the control device 12 receives the request, the device information providing module 27 obtains device information of the control device 12 and transmits the device information to the smart electronic device 11 via the second communication unit 121. In the embodiment, the device information includes the name of the control device 12 and the download address of the corresponding control software.

After the first communication unit 112 of the smart electronic device 11 receives the device information transmitted from the control device 12, the display control module 1131 controls the display unit 114 to display the received device information.

The determination module 24 determines whether there is control software in the storage unit 111 corresponding to the detected control device 12 according to the name of the control device 12 contained in the received device information. If there is control software corresponding to the control device 12, the determination module 23 further determines whether the control software corresponding to the control device has been installed on the smart electronic device 11. If the control software has not been installed on the smart electronic device 11, the installation module 26 installs the corresponding control software on the smart electronic device 11.

If the determination module 24 determines that there is no control software in the storage unit 111 corresponding to the detected control device 12, the downloading module 25 downloads the control software corresponding to the control device 12 from the Internet according to the download address contained in the received device information, and further stores the downloaded control software in the storage unit 111. The installation module 26 then installs the downloaded control software on the smart electronic device 11.

As illustrated in FIG. 1, the smart electronic device 11 can further include an input unit 115. The input unit 115 can be a touch sensitive screen, a touchpad, a keypad, a microphone, or other suitable input device. The control software installed on the smart electronic device 11 can control the smart electronic device 11 to generate a control signal in response to a user's operation via the input unit 115. The first communication unit 112 of the smart electronic device 11 transmits the control signal to the control device 12. The control device 12 generates a command according to the control signal, and the second communication unit 121 of the control device 12 transmits the command to the terminal 13. The terminal 13 receives and executes an operation in response to the command.

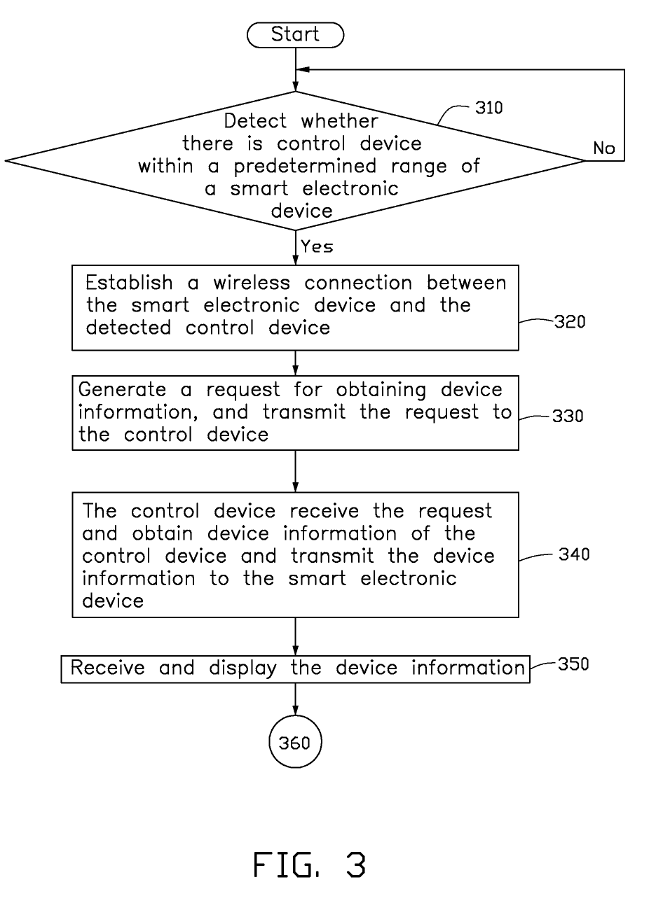

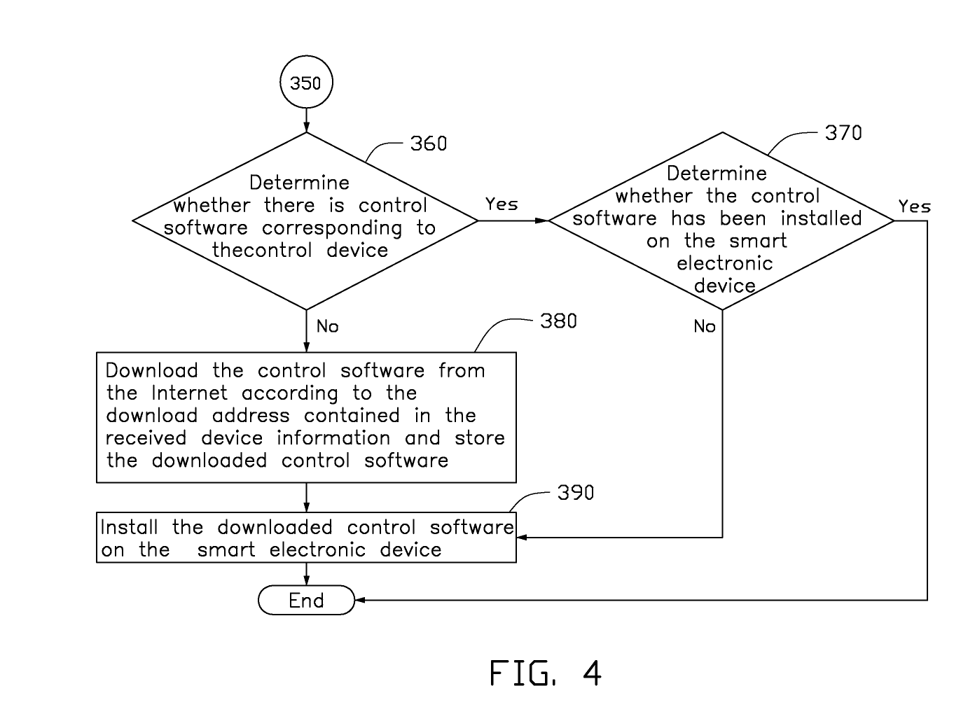

FIGS. 3 and 4 together constitute a single flowchart of an embodiment of a method for downloading control software and installing the control software on a smart electronic device.

In block 310, the detection module detects whether there is a control device within a predetermined range of the smart electronic device. If so, the procedure goes to block 320. Otherwise, the procedure goes to block 310.

In block 320, the connection module establishes a wireless connection between the smart electronic device and the detected control device.

In block 330, the device information acquisition module generates a request for obtaining device information of the detected control device and controls the first communication unit to transmit the request to the detected control device.

In block 340, the second communication unit of the detected control device receives the request, and the device information providing module controls the detected control device to obtain the device information of the control device and controls the second communication unit to transmit the device information to the smart electronic device.

In block 350, the first communication unit receives the device information, and the display control module controls the display unit to display the device information.

In block 360, the determination module determines whether there is control software corresponding to the detected control device. If so, the procedure goes to block 370; otherwise, the procedure goes to block 380.

In block 370, the determination module determines whether the control software corresponding to the control device has been installed on the smart electronic device. If so, the procedure ends, otherwise, the procedure goes to block 390.

In block 380, the downloading module downloads the control software from the Internet according to the download address contained in the received device information and stores the downloaded control software in the storage unit.

In block 390, the installation module installs the downloaded control software on the smart electronic device.

Although the present disclosure has been specifically described on the basis of various embodiments thereof, the disclosure is not to be construed as being limited thereto. Various changes or modifications may be made to the embodiments without departing from the scope and spirit of the disclosure.

What is claimed is:

1. A method for downloading and installing control software on a smart electronic device, the method comprising:
generating a request for obtaining device information of a control device, and transmitting the request to the control device;
receiving the device information transmitted from the control device, wherein the device information comprises a download address of the control software;
downloading the control software from the Internet according to the download address;
installing the downloaded control software on the smart electronic device.

2. The method as described in claim 1, further comprising steps before generating a request for obtaining the device information of the control device, and transmitting the request to the control device, the steps comprising:
detecting whether there is a control device within a predetermined range of the smart electronic device; and
establishing wireless connection between the smart electronic device and the detected control device when there is a control device within the predetermined range of the smart electronic device.

3. The method as described in claim 2, further comprising steps before downloading the control software from the Internet according to the download address, the steps comprising:
determining whether the control software corresponding to the control device has been stored in the smart electronic device, wherein the control software is downloaded from the Internet according to the download address if the control software has not been stored in the smart electronic device.

4. The method as described in claim 3, the method determining whether the control software corresponding to the control device has been stored in the smart electronic device further comprising:
determining whether the control software has been installed on the smart electronic device if the control software has been stored in the smart electronic device; and
installing the control software on the smart electronic device if the control software has not been installed on the smart electronic device.

5. The method as described in claim 1, further comprising:
displaying the received device information after receiving the device information transmitted from the control device.

6. A smart electronic device comprising:
a communication unit;
a processor; and
a plurality of modules executable by the processor, the plurality of modules comprising:
an device information acquisition module to generate a request for obtaining device information of a control device, control the communication unit to transmit the request to the control device, and control the communication unit to receive the device information containing a download address of control software transmitted from the control device;
a downloading module to download the control software from the internet according to the download address; and
an installation module to install the downloaded control software on the smart electronic device.

7. The smart electronic device as described in claim 4, further comprising:
a detection module, executable by the processor, to control the smart electronic device to detect whether there is a control device within a predetermined range of the smart electronic device; and
a connection module, executable by the processor, to establish wireless connection between the smart electronic device and the control device when there is a control device within the predetermined range of the smart electronic device.

8. The smart electronic device as described in claim 7, further comprising a determination module, executable by the processor, to determine whether there is control software corresponding to the control device when the device information is received, the downloading module is configured to download the control software from the Internet when there is no control software corresponding to the control device.

9. The smart electronic device as described in claim 8, wherein the determination module is further configured to determine whether the control software has been installed on the smart electronic device, and the installation module is further configured to install the control software on the smart electronic device when the control software has not been installed on the smart electronic device.

10. The smart electronic device as described in claim 6, further comprising a display unit, wherein the processor is configured to control the display unit to display the received device information.

11. A system for downloading and installing control software on a smart electronic device, the system comprising:
a plurality of modules executable by the smart electronic device and a control device, wherein the smart electronic device comprises a first communication unit and the control device comprises a second communication unit, the modules comprising:
a device information acquisition module to generate a request for obtaining device information of the control device, and control the first communication unit to transmit the request to the control device and control the first communication unit to receive device information containing a download address of control software corresponding to the control device transmitted from the control device;
a device information providing module to control the control device to obtaining the device information and control the second communication unit to transmit the device information to the smart electronic device;
a downloading module to download the control software from the Internet according to the download address; and
an installation module to install the downloaded control software on the smart electronic device.

12. The system as described in claim 11, further comprising:
a detection module to control the smart electronic device to detect whether there is a control device within a predetermined range of the smart electronic device; and
a connection module to establish wireless connection between the smart electronic device and the detected control device when there is a control device within the predetermined range of the smart electronic device.

13. The system as described in claim 12, further comprising a determination module to determine whether there is control software corresponding to the control device when the device information is received, wherein the control software is downloaded from the Internet when there is no control software corresponding to the control device.

14. The system as described in claim 13, wherein the determination module is further configured to determine whether the control software has been installed on the smart electronic device, and the installation module is further configured to install the control software on the smart electronic device when the control software has not been installed on the smart electronic device.

15. The system as described in claim 11, wherein the device information acquisition module, the connection module, the installation module, the detection module, the downloading module, the connection module, and the determination module are executable by the processor of the smart electronic device, and the device information providing module is executable by the control device.
